(19) United States
(12) Patent Application Publication
(10) Pub. No.: US 2008/0033798 A1
(43) Pub. Date: Feb. 7, 2008

(54) DELIVERING INFORMATION TO A CLIENT DEVICE IN A COMMUNICATION-CHALLENGED ENVIRONMENT

(76) Inventors: John G. Carey, Sammamish, WA (US); Quentin S. Miller, Sammamish, WA (US); John J. Ostlund, Redmond, WA (US)

Correspondence Address: LEE & HAYES PLLC, 421 W RIVERSIDE AVENUE SUITE 500, SPOKANE, WA, 99201, US

(21) Appl. No.: 11/462,661

(22) Filed: Aug. 4, 2006

(51) Int. Cl. G06Q 30/00

(52) U.S. Cl. 705/14

(57) ABSTRACT

A strategy is described for delivering information items to a client device in response to download events. At some time later, the client devices present the information items to users in response to respective delivery events. The strategy is particularly beneficial in those environments characterized by non-real-time request-response performance, such as network environments characterized by significant levels of latency and/or intermittent connectivity. The strategy overcomes this non-real-time performance by downloading relevant information items to users before the items are delivered, thus making the information items more readily available when actually needed. Other provisions are provided for ensuring that valid accounting is applied to the delivery of information items, and for allocating revenue based on this accounting. In one implementation, the information items correspond to advertisements.

### BACKGROUND

Many types of network environments offer real-time roundtrip request-response performance. That is, in these environments, when a client device makes a request for information, a server system (or other functionality) can quickly forward a response to the client device. Since the response closely follows the request, the user perceives the network environment as effectively providing real-time performance.

Consider, for instance, the now ubiquitous technology for generating advertising s messages (“ads”) in response to a user's online activity. In this technology, the user may make a selection using a client device, such as by accessing an application pertaining to a particular topic, or by entering a particular keyword into a search engine. Advertising functionality located at a server site can receive the user's triggering selection and provide an ad that is relevant to the user's selection. If the client device is connected to the network environment via a high speed connection, the advertising functionality can provide the relevant ad to the user almost immediately after the user makes the triggering selection. The user can therefore receive advertising content that is related to the current context of the user's activities.

Other environments, however, do not offer real-time request-response performance, or are at least characterized by episodes of such non-real-time behavior. These kinds of environments are generally referred to herein as “communication-challenged environments.” One variety of this kind of environment suffers from unsatisfactory latency in responding to client requests. In this kind of environment, there is a significant time lag between a client device's request for information and the delivery of such information to the client device. Another variety of this kind of environment suffers from connectivity issues. In this kind of environment, the client device cannot always access the server system when needed, and thus, the client device obviously cannot receive immediate replies to its requests in these circumstances. To cite merely one example, a mobile device typically operates in a wireless environment that may provide unsatisfactory performance in terms of both latency and connectivity.

Communication-challenged environments have a number of drawbacks. Consider the above-identified example of advertising technology. As described, advertising functionality attempts to expose the user to ads that are relevant to the user's current interaction with the environment, as evidenced, for instance, by the user's current online selections. However, in a communication-challenged environment, the advertising functionality may not be able to furnish the user with ads immediately after the user makes a triggering selection. As a result, when the user does receive the ads, the context of the user's interaction with the environment may have changed. The user may therefore receive ads that are perceived as out of place.

For at least one or more of the above-identified exemplary and non-limiting reasons, there is a need in the art for a more satisfactory strategy for delivering information to client devices in communication-challenged environments.

### SUMMARY

A strategy is described for downloading an information item to a store of a client device. Later, in response to a delivery event, the client device can retrieve the information item from its local store and deliver it to the user. Since the client device locally stores the information item, it can quickly access the information item when needed. In other words, by avoiding the need to contact a remote service at the time of delivery, the technique circumvents latency and connectivity problems that may be present in communication-challenged environments.

According to one exemplary application, the information items correspond to advertisements (“ads”) that are selected to complement a context in which the user is (or will be) interacting with a computing environment.

According to another exemplary feature, the strategy includes a provision for removing or deactivating information items that have been downloaded to the client device.

According to another exemplary feature, the strategy generates accounting information in response to the delivery of an information item (or in response to a subsequent user action taken with respect to the delivered information item). Based on the accounting information, the strategy can identify one or more participants associated with the delivery of the information item. The strategy can then allocate revenue associated with the delivery of the information item among the participants. The strategy can also help certify that the accounting information reflects the occurrence of a valid information item delivery event.

This Summary section refers to exemplary and non-limiting manifestations of the subject matter described herein, and hence does not limit the scope of the invention set forth in the Claims section.

### BRIEF DESCRIPTION OF THE DRAWINGS

FIG. 1 shows an exemplary system for downloading information items to client devices, in advance of the consumption of the information items by users.

FIG. 2 shows a sequence of events that explain one exemplary manner of operation of the system of FIG. 1.

FIG. 3 shows an exemplary client device and information downloading service (IDS) for use in the system of FIG. 1, in the exemplary context of an advertisement dissemination environment.

FIG. 4 shows exemplary ad administration modules for use in the client device and IDS of FIG. 3.

FIG. 5 shows exemplary accounting functionality for processing accounting information associated with the delivery of information items.

FIG. 6 shows exemplary processing functionality that can be used to implement any component shown in the preceding figures.

FIG. 7 is a flowchart that sets forth an overview of one exemplary manner of operation of the system of FIG. 1, in the context of an advertisement dissemination environment.

FIG. 8 is a flowchart that sets forth one exemplary manner for adding and expiring ads in the process shown in FIG. 7.

FIG. 9 is a flowchart that sets forth one exemplary manner for delivering previously downloaded ads to users in the process shown in FIG. 7.

FIG. 10 is a flowchart that sets forth one exemplary manner of processing accounting information associated with the delivery of ads in the process shown in FIG. 7.

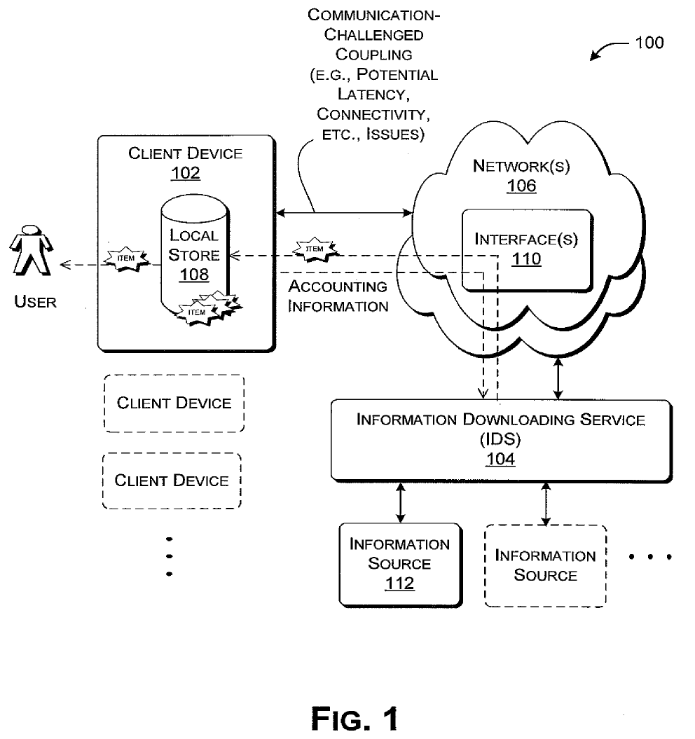

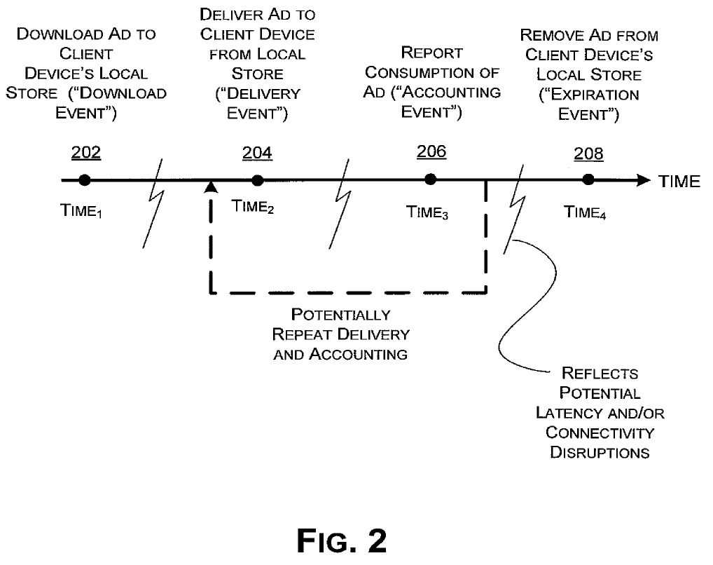

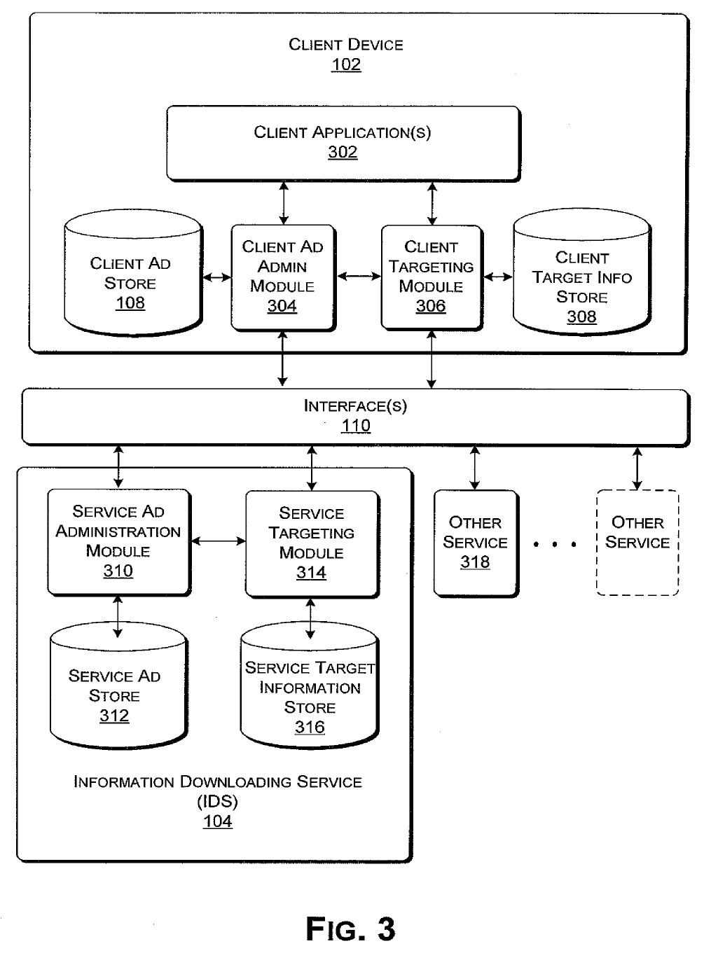

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth a strategy for downloading an information item to a client device in response to a download event. Then, at some time later, the client device retrieves and presents the information item to a user in response to a delivery event. Since the client device locally stores the information item, it can immediately display this item, irrespective of latency and/or connectivity complications that may impair real-time communication with a remote service.

The term “information item” can encompass any kind of data, including text, still images, video, audio, program content, markup content, Flash content, hyperlinks, and so on. Further, the information item can serve any purpose. In the exemplary application most commonly evoked herein, the information item corresponds to an advertising message (an “ad”) that attempts to induce the user to purchase a product or service. Other applications may use information items to serve other commercial objectives or non-commercial objectives.

The term “communication-challenged environment” refers to any environment that provides non-real-time roundtrip request-response performance, or at least provides episodes of such behavior (or the mere potential of such behavior). In non-real-time roundtrip request-response performance, a network environment does not provide a quick response to a triggering event, as perceived by a user. What is considered a “quick response” may depend, in part, on the nature of the application with which the user is interacting. In one exemplary and non-limiting environment, a non-real-time response may constitute a response that exceeds a few seconds.

The disclosure includes the following sections: Section A sets forth an exemplary system for implementing an information delivery strategy; Section B describes one exemplary manner of operation of the system of Section A.

A. Exemplary System (FIGS. 1-6)

As a preliminary matter, any of the functions described with reference to the figures can be implemented using software, firmware, hardware (e.g., fixed logic circuitry), manual processing, or a combination of these implementations. The term “logic, “module” or “functionality” as used herein generally represents software, firmware, hardware, or a combination of software and hardware. For instance, in the case of a software implementation, the term “logic,” “module,” or “functionality” represents program code (or declarative content) that is configured to perform specified tasks when executed on a processing device or devices (e.g., CPU or CPUs). The program code can be stored in one or more computer readable media.

More generally, the illustrated separation of logic, modules and functionality into distinct units may reflect an actual physical grouping and allocation of such software, firmware, and/or hardware, or can correspond to a conceptual allocation of different tasks performed by a single software program, firmware program, and/or hardware unit. The illustrated logic, modules and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, solid state, etc.). The term machine-readable media also encompasses transitory forms of representing information, including various hardwired and/or wireless links for transmitting the information from one point to another.

A.1. Overview of an Exemplary System

FIG. 1 shows one exemplary system 100 for implementing the principles described herein. FIG. 1 depicts the system 100 as including a representative client device 102 coupled to an information downloading service (IDS) 104 via one or more networks 106. By way of broad overview, the client device 102 receives an information item from the IDS 104 in response to a download event, whereupon the client device 102 stores the information item in a local store 108. At a later time, the client device 102 retrieves the information item from its local store 108 in response to a delivery event, and then presents this item to a user for consumption. Because the client device 102 accesses the information item from a local source when it is needed (rather than from the IDS 104), the client device 102 can quickly present the information item for the user's consumption. Through this provision, the system 100 circumvents any latency and/or connectivity problems in the coupling between the client device 102 and the IDS 104. The following explanation elaborates on each of the features shown in FIG. 1.

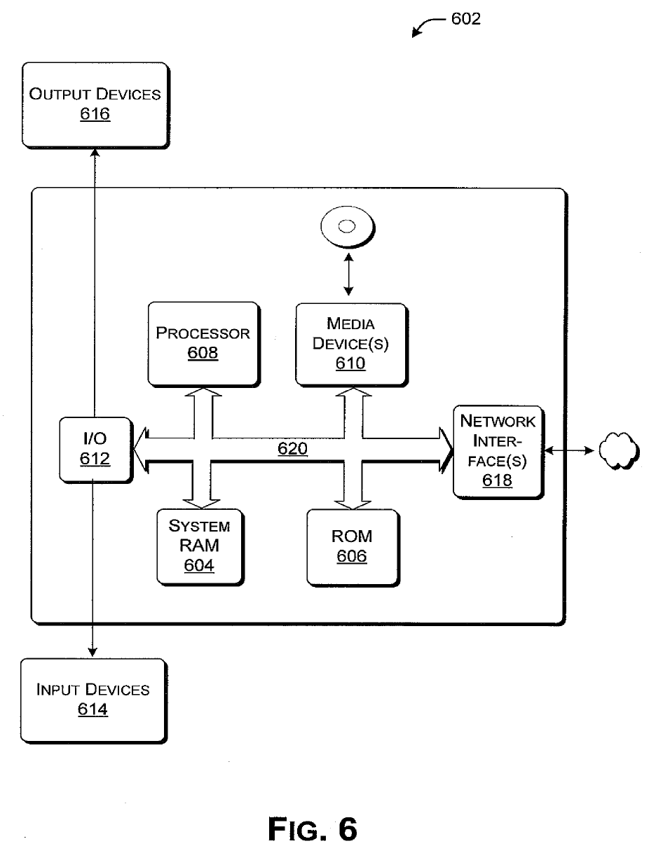

The client device 102 represents one of a plurality of client devices. This device can be implemented as any type of processing device for interacting with the system 100. For example, the client device 102 may comprise a mobile computing device that interacts with the networks 106 via wireless communication. Exemplary types of mobile computing devices include mobile telephones, personal digital assistants (PDAs), laptop computers, various types of wearable computing devices, and so forth. Or the client device 102 can represent a stationary type of computing device, such as a personal computer, and so forth. The client device 102 can implement its functions using any combination of software, firmware, and/or hardware. FIG. 6, to be described in turn, depicts one exemplary implementation of the client device 102.

The client device's 102 local store 108 may represent any kind of storage that is readily accessible to the client device 102 In the case most often evoked here, the local store 108 represents any kind of volatile and/or non-volatile storage medium located within the housing of the client device 102, or otherwise physically coupled to the client device 102. For instance, the local store 108 can represent a non-volatile memory that is physically attached to a main circuit board (not shown) of the client device 102. Or the local store 108 can represent a memory unit (e.g., a memory card, stick, disc, etc.) that detachably couples to the client device 102. In other cases, the local store 108 represents a storage medium that is locally accessible to the client device 102 via any type of communication path, but is not otherwise physically associated with the client device 102. For example, the local store 108 can be implemented as a common repository of information items that is accessible to a nearby group of client devices through a high-speed connection. For example, a company, university, neighborhood, etc. can maintain a local store 108, which can be reliably accessed by affiliated client devices.

The networks 106 represent one or more communication conduits for coupling the client device 102 to the IDS 104. For example, the networks 106 can include any kind of digital network governed by any combination of protocols, including one or more wide-area-networks (WANs), one or more local-area-networks (LANs), and so on. In one implementation, the networks 106 include a packet-based digital network, such as the Internet. In addition, the networks 106 can include one or more telecommunication networks, such as one or more conventional landline telephone networks, one or more mobile telephone networks, a satellite-based network, and so forth. The networks 106 can also include one or more gateway interfaces 110. A gateway interface allows one type of network to interface with another type of network. For example, an exemplary gateway interface can allow a mobile telephone network to interface with the Internet, and vice versa. A gateway interface can perform this function by converting between different formats, protocols, etc.

In any event, the networks 106 that couple the client device 102 to the IDS 104 represent a so-called communication-challenged environment. As explained above, a communication-challenged environment represents a connection that does not ensure real-time request response-performance. Namely, in response to a triggering event from the client device 102 or a backend component of the IDS 104, the networks 106 cannot be relied upon to deliver information items to the client device 102 in a real-time fashion (as perceived by a user). In one case, for example, the client device 102 receives a reply from the IDS 104 a significant amount of time after making a request. This represents a latency-related shortcoming. In another case, the client device 102 may not be able to access the IDS 104 at all. This represents a connectivity-related shortcoming. Certain networks 106 may have latency-related problems, other networks 106 may have connectivity-related problems, while still other networks may have both types of problems.

One example of an environment that suffers from both latency-related and connectivity-related shortcomings is a mobile device network. In this type of environment, while the client device 102 remains in communicative contact with the system 100, the system may take several seconds to process a request by the client device 102. In other instances, the client device 102 may entirely lose connection with the system 100, such as when the client device 102 roams outside the coverage of a mobile telephone system, or enters a location in which connection is blocked. Another example of environment that suffers from latency-related and/or connectivity-related problems is an environment that uses dial-up-type modems to access a network. These examples are merely representative; still other types of networks can be characterized as communication-challenged.

The information downloading service (IDS) 104 represents any functionality for downloading information items to the client device 102 and performing other operations to be described below. The IDS 104 can be implemented by one or more server-type computer devices which couple to a wide-area-network, such as the Internet, in potential cooperation with other computer-related equipment, such as various storage devices, etc. The server-type computer devices can be located at a single site or distributed over plural sites. FIG. 6, to be discussed below, shows processing functionality that can also generically represent an exemplary server-type computer.

The IDS 104 can interact with one or more other entities, such as one or more information sources, including representative information source 112. The information source 112 may represent functionality that supplies information items to the IDS 104 for dissemination to the client device 102. For example, the information source 104 may represent functionality administered by an advertiser, which supplies advertisements to the IDS 104. The information source 112 can be implemented by a separate computer system, such as one or more server-type computer devices (not shown). The information source 112 can be coupled to the IDS 104 via any type of network or combination of networks, such as the Internet. The network that couples the information source 112 to the IDS 104 can form part of the networks 106 described above.

FIG. 2 shows exemplary principal events which characterize the operation of the system 100 of FIG. 1. To present a concrete frame of reference for the following explanation, the events will be explained in the context of the dissemination of advertisements (“ads”), although the principles described below can be applied to any other type of information items.

* Download Event

A first type of event corresponds to a download event 202. In the download event 202, the IDS 104 forwards one or more ads to the client device 202 in response to a triggering circumstance. Two issues relate to the manner in which the IDS 104 performs this role. A first issue concerns what circumstances will trigger the downloading of ads to the client device 102. A second issue concerns what ads should be downloaded upon occurrence of the triggering circumstances.

As to the first issue, a triggering circumstance can originate from anywhere within the system 100. For instance, the triggering circumstance can stem from actions taken by the user. For example, a user can enter information (such as search terms) into the system 100 via the client device 102, which prompts the IDS 104 to download one or more ads. Or the user can activate an application, which prompts the IDS 104 to download one or more ads, e.g., in response to the initial activation of the application or at predetermined junctures within the application (as potentially determined by the designer of the application). Or the user can send or read an Email or other kind of message, which again prompts the IDS 104 to download one or more ads.

In another instance, the triggering circumstance may represent activity which occurs within the IDS 104, independent of any input made by the user at the client device 102. For instance, the IDS 104 can be configured to periodically download ads at predetermined times, or when other user-independent conditions are met. In yet another instance, the triggering circumstance may represent activity which occurs at the information source 112. For example, in an advertising scenario, the information source 112 may present a system maintained by a sponsor of advertisements. Such a sponsor may manage a promotional campaign that, at various times, calls for the downloading of ads to the client device 102 via the IDS 104.

In other circumstances, the downloading of ads is based on various combinations of the above-described occurrences. For example, in one case, the IDS 104 can maintain its own repository of ads. The IDS 104 can select these ads in response to any triggering circumstance, such as any event described above (and/or any event which will be described below). But rather than downloading the ads immediately after the triggering circumstance, the IDS 104 can periodically download its ads to the local store 108 of the client device 102. Through this operation, the IDS 104 periodically synchronizes its store with the local store 108 of the client device 102. The “download event” in this scenario most directly reflects the circumstances that govern the periodic downloading operation, but also indirectly reflects the circumstances which prompt the selection of the ads in the first place by the IDS 104.

Still other triggering circumstances may prompt the IDS 104 to download ads to the client device 102.

As to the second issue identified above, the IDS 104 can apply one or more rules to determine what ads to download to the client device 102. In general terms, the IDS 104 can determine the context of the user's interaction with the system 100. The IDS 104 can then select one or more ads that have a bearing on the context. To perform this function, the IDS 104 can identify targeting information that represents the context, and then select ads based on this targeting information. Different components within the system 100 can collect such targeting information, including the client device 102, the IDS 104, the information source 112, and/or possibly some other component or combination of multiple components.

The IDS 104 can rely on different kinds of targeting information in selecting ads. A first type of targeting information is immediate, meaning that it reflects the current behavior of the user or some other contemporaneous occurrence within the system 100. For instance, the user's selections can be mined for information regarding the interests of the user. For example, the user's selection of an application reflects the user's potential interest in a topic (or topics) associated with the application. The user's input of a search query reflects the user's potential interest in a subject related to the keywords in the search query. The user's generation or receipt of an Email or other kind of message reflects the user's potential interest in information being imparted by these messages, and so on. Well known techniques can be used to map the above-described types of triggering information into related ads. For instance, advertisers can bid on certain keywords that will trigger the presentation of ads when these keywords appear in certain content that the user inputs or otherwise selects.

Other types of immediate targeting information may be independent of the user's input selections. For example, the location of the client device 102 can constitute targeting information which can be used to select ads.

A second type of targeting information reflects more long-term characteristics of the user. For example, the IDS 104 can create a profile that describes certain characteristics of the user, e.g., by expressly asking the user to input this information or by otherwise collecting this information from available database sources. Such profile information can include the user's gender, hobbies, age, marital status, educational background, and so on. Or the IDS 104 can automatically infer the characteristics of the user based on patterns in the user's online behavior. The IDS 104 can then present ads that have a bearing on the characteristics defined in the user's profile. For instance, if the user is known to frequently visit websites related to fishing, it may be reasonably inferred that the user has an active interest in the topic of fishing. The IDS 104 can therefore download ads related to fishing to the client device 102.

Other types of long-term targeting information may be independent of the user's input selections. For example, ads can be selected, at least in part, based on characteristics of the client device 102, including the processing capabilities of the client device 102, the display capabilities of the client device 102, the programming or markup languages utilized by the client device 102, the manufacturer of the client device 102, and so on. These properties constitute a client device profile. Ads can also be selected based on properties and affiliations of the networks 106, the gateway interfaces 110, the IDS 106, the information source 112, and so on.

Regardless of whether the targeting information reflects immediate or long-term information, the selection of ads may also rely on forecasting analysis. That is, recall that a time lag may separate a download event from the actual delivery of the ad. For example, the IDS 104 can periodically download relevant ads, whereupon the client device 102 draws from this pool at various times after these download events. Therefore, in addition to assessing the current context of the user's interaction with the system 100, the IDS 104 may attempt to anticipate the context that will likely prevail when ads are actually delivered to the user. Based on this forecasting analysis, the IDS 104 can then select ads which complement the projected context.

In the above-described scenarios, the IDS 104 can optionally compress the ads before downloading the ads to the client device 102. This improves the timeliness in which the client device 102 can receive the ads. Any kind of compression technique can be used, such as JPEG-type techniques (for image content), Lempel Ziv-type techniques (as used in “Zip” files), and so on.

In an alternative implementation, instead of electronically downloading ads, the local store 108 can be pre-configured to store a collection of ads in its local store 108. In another implementation, the system 100 can send the client device 102 a new collection of ads by shipping the user a portable medium (such as a magnetic or optical disc) that contains the new ads.

*Delivery Event

In response to a download event, the client device 102 can store an ad in its local memory 108 until it is retrieved for presentation to the user. The “delivery” of an ad refers to the presentation of the ad to the user. Any period of time may separate the receipt of an ad and its delivery. A so-called delivery event 204 represents the triggering circumstance which prompts the retrieval of the ad. It should be noted, however, that a downloaded ad is not necessarily delivered. That is, some ads go “unused.”

Any type of user action associated with a download event (described above) can also represent a delivery event. The selection of an ad in a download context may also parallel the selection of an ad in a delivery context. For example, assume that the user sends several Emails containing text related to fishing, or that the user repeatedly activates an application related to fishing. In response, the IDS 104 may infer that the user is interested in fishing and thus download one or more ads pertaining to fishing. Then, the next time that the user sends an Email or activates an application pertaining to fishing, the client device 102 can retrieve an ad related to fishing from its local store 108. Because the client device 102 relies on its local store 108, it does not need to access the IDS 104, and therefore it can circumvent any latency and/or connectivity problems that may be present in the system 100 at the time of ad delivery. For instance, suppose that the client device 102 is a mobile telephone. Further assume that an ad delivery opportunity occurs while the user is traveling through a tunnel. Although the user may not be able to access the IDS 104, the user can still receive a pertinent ad.

In another case, a delivery event may be triggered by circumstances which are independent of actions taken by the user. For example, the client device 102 can present randomly-selected ads at predetermined times, or predetermined ads at random times, or randomly-selected ads at random times, and so on. Or the IDS 104 and/or information source 112 can trigger the delivery of previously downloaded ads.

Still other factors may prompt the system 100 to deliver previously downloaded ads.

*Accounting Event

The economic viability of advertising systems generally depends on the collection of revenue associated with the delivery of ads. In connection therewith, the system 100 records when an ad is presented or when some action is taken with respect to a presented ad. This type of recordation marks a so-called accounting event 206.

In one case, an accounting event is triggered when an ad is simply presented. This model of recordation uses a cost-per-impression accounting strategy. Another account event is triggered when the user takes some action pertaining to a presented ad. This model of recordation uses a cost-per-action accounting strategy. A common form of cost-per-action accounting registers a revenue-accruing event when a user clicks on a presented ad. Another form of cost-per-action accounting registers a revenue-accruing event when a user fills out a form, makes a telephone call to a sales representative, purchases an item or service, and so forth.

Different components in the system 100 can register accounting events. For instance, the client device 102 can register an accounting event when it requests an ad from the IDS 104, when it delivers an ad to the user, and/or when it detects that the user has taken some action with respect to a delivered ad. The IDS 104, information source 112, or some other component (or combination of components) can also play a part in generating ad events.

As will be described in greater depth below, the system 100 generates accounting information in response to an accounting event. The accounting information can reflect salient information regarding the ad-related transaction, such as the identity of the ad that was involved in the transaction and what actions the user has performed with respect to the ad. The accounting information can also identify the participants that were involved in the delivery of the ad. An accounting service can receive the accounting information, extract data from the accounting information, and allocate revenue among the identified participants based on the extracted data. As will be described, the system 100 can also employ various safeguards to better ensure that received accounting information represents legitimate accounting events (as opposed to artificially-generated accounting information produced with the intent of fraudulently skewing the accounting calculations.)

*Expiration Event

The system 100 may act to remove one or more ads that have been previously downloaded to the local store 108. The circumstances which prompt the removal (or deactivation) of ads in the local store 108 demarcate expiration events 208. Any component within the system 100 can orchestrate the expiration of an ad, including the client device 102, the IDS 104, the information source 112, and so forth (or any combination of these components). To facilitate discussion, FIG. 2 shows that the expiration event 208 follows a single delivery event 204 and accounting event 206. But more generally, as indicated by the dashed-line loop, any number of delivery and accounting events can precede the expiration of an ad (or possibly no such events precede the expiration of an ad).

An expiration event 208 may result from different occurrences. In one case, the system 100 removes an ad after it has been presented a predetermined number of times (such as once, twice, etc.). In another case, the system 100 removes an ad after a predetermined amount of time has expired after it has been downloaded, regardless of how many times it has been presented (including the possibility that it has never been presented).

In another case, the system 100 can remove an ad when an advertising context is determined to have changed, making the ad no longer relevant. For example, assume that, in the summer months, the user exhibits a pattern of online behavior that evinces an interest in fishing. But in winter months, the user's pattern of behavior changes, evincing a new interest in skiing. In response to this determination, the system 100 can replace previously downloaded fishing-related ads with skiing-related ads.

The advertiser or other entity may play a part in determining when an ad should be retired. For instance, the advertiser can pay a fee that is proportional to the amount of time that an ad is allowed to remain active within the local store 108 of a client device, or a fee that is proportional to the amount of times an ad may be presented before it is removed. In other cases, the system 100 can remove an ad in response to express instructions from the advertiser or from some other party.

The removal of an ad can free up storage space in the local store 108, and therefore provides an opportunity to download one or more new ads to the client device 102. In other words, an expiration event may also trigger a download event.

The examples set forth above are representative and non-limiting. The expiration of an ad can be predicated on yet other triggering circumstances.

A.2. Exemplary Composition of a Client Device and IDS

FIG. 3 shows an exemplary composition of the client device 102 and the IDS 104 in greater detail, which are coupled together via the interface(s) 110. The functions performed by the system 100 can be allocated in different ways between the client device 102 and the IDS 104, or among the client device 102, IDS 104 and yet some other component (such as the advertising information source 112). The below-described implementation of the client device 102 and the IDS 104 is therefore only one of many possible implementations. In view of this, a function which is described below in the context of client-level processing can equally well be performed by service-level processing, and vice versa, or by a combination of client-level processing and service-level processing.

The client device 102 can include one or more client applications 302. The client applications 302 can perform any type of function for use in any kind of environment. Exemplary types of applications include e-commerce related applications, instant messaging applications, Email applications, database management applications, search applications, and so on.

The client device 102 also includes a client ad administration module 304. The purpose of the client ad administration module 304 is to perform all administrative functions associated with the handling of ads, such as receiving and storing new downloaded ads, selecting and delivering previously downloaded ads, deleting or deactivating previously downloaded ads, reporting the delivery of downloaded ads (or some other revenue-generating action associated with delivered ads), and so forth. The client ad administration module 304 stores downloaded ads in the client local ad store 108 previously introduced in the context of FIG. 1). As explained above, the client local ad store 108 may represent a volatile or non-volatile storage, physically located within a housing (not shown) of the client device 102, or located separate from the client device 102.

The client device 102 also can include a client targeting module 306. The purpose of the client targeting module 306 is to collect targeting information. The targeting information comprises any information that is used to select ads for downloading to the client device 102 (and/or to select already downloaded ads for delivery to the user). For example, the client targeting module 306 can collect information regarding the characteristics of the users the selections made by the user, the applications being run by the user, the messages sent and received by the user, and so forth. Through interaction with the client ad administration module 304 and client applications 302, the targeting module 306 can also store information regarding the properties of the client device 102 (such as the identity of the client device 102), the identity of the user, and so on. The client targeting module 306 stores the thus-collected targeting information in a client target information store 308.

The information downloading service (IDS) 104 includes components which complement the components of the client device 102. For instance, the IDS 104 can include a service ad administration module 310 in conjunction with a service ad store 312. The purpose of the service ad administration module 310 is to perform all administrative functions associated with the handling of ads, from the perspective of the IDS 104, in cooperation with the client ad administration module 304. Such functions include downloading ads to client devices, sending instructions to remove previously downloaded ads, receiving accounting information which indicates the delivery of ads (or other revenue-accruing operations associated with the delivered ads), and so forth. In a first solution, the service ad administration module 310 can maintain separate collections of ads for downloading to different respective client devices and/or different respective applications provided by the client devices. In a second solution, the service ad administration module 310 can maintain a common pool of ads for downloading to a group of client devices (and/or applications) that share common characteristics. A third solution provides a hybrid of the first two solutions.

In one exemplary implementation, the system 100 may endeavor to synchronize the contents of the client ad store 108 with at least parts of the service ad store 312 through interaction between the client device 102 and the IDS 104. More specifically, the service ad administration module 310 can continually monitor the advertising context in the system 100 based on any one or more of the context parameters described above. (As explained above, exemplary context parameters may reflect the activity of the users, the nature of the applications being invoked, the identity of various participants in the system, the nature of messages sent and received, and so on.) Based on these considerations, the service ad administration module 310 can select ads in the manner described above. The service ad administration module 310 can then periodically download these ads to the local store 108 of the client device 102. By virtue of repeated downloading operations, the system 100 seeks to duplicate at least parts of the contents of the service ad store 312 in the local client store 108, thereby synchronizing these ad stores.

The IDS 104 can also include a service ad targeting module 318 in conjunction with a service target information store 316. The purpose of the service targeting module 314 is to collect targeting information in cooperation with the client target module 306. As described above, the targeting information comprises any information that is used to select ads for downloading to the client device 102 (and/or to select already downloaded ads for delivery to the user). For example, the service targeting module 314 can collect information regarding the characteristics of the user, the selections made by the user, the applications being run by the user, the messages sent and received by the user, and so forth. In one case, the service targeting module 314 can perform its own targeting-related analysis based on raw data received from the client devices and other sources. In another case, the service targeting module 314 can act as a clearinghouse for processing targeting information gleaned by one or more client targeting modules 306. Generally, in one implementation, like the case of the ad stores, the system 100 may endeavor to synchronize the contents of the client target information store 308 with at least parts of the service target information store 316 through interaction between the client device 102 and the IDS 104.

To summarize, note that the client device 102 and the IDS 104 are integrated in performing the common task of delivering ads to the user. Yet the client device 102 and IDS 104 can also perform independent analyses in connection with this common task. For instance, even if the client device 102 cannot access the IDS 104, its modules (304, 306) remain active and capable of selecting previously downloaded ads for delivery to the user upon a delivery event. For instance, the profile information stored in the client target information store 308 can be used to select previously downloaded ads for delivery to the user.

The client device 302 can interact with the IDS 104 via one or more gateway interfaces 110. As previously described, a gateway interface allows messages expressed according to the format and protocol of a first network environment (such a mobile telephone network) to be converted to the format and protocol of a second network environment (such as a digital packet-based network, such as the Internet), and vice versa.

Finally, FIG. 3 shows that, in addition to the IDS 104, the client device 102 can interact with other remote services, such as other service 318. The other service 318 can represent any kind of processing functionality (e.g., one or more server-type computers, databases, etc.) for performing any kind of function.

A.3. Overview of the Client and IDS Ad Administration Modules

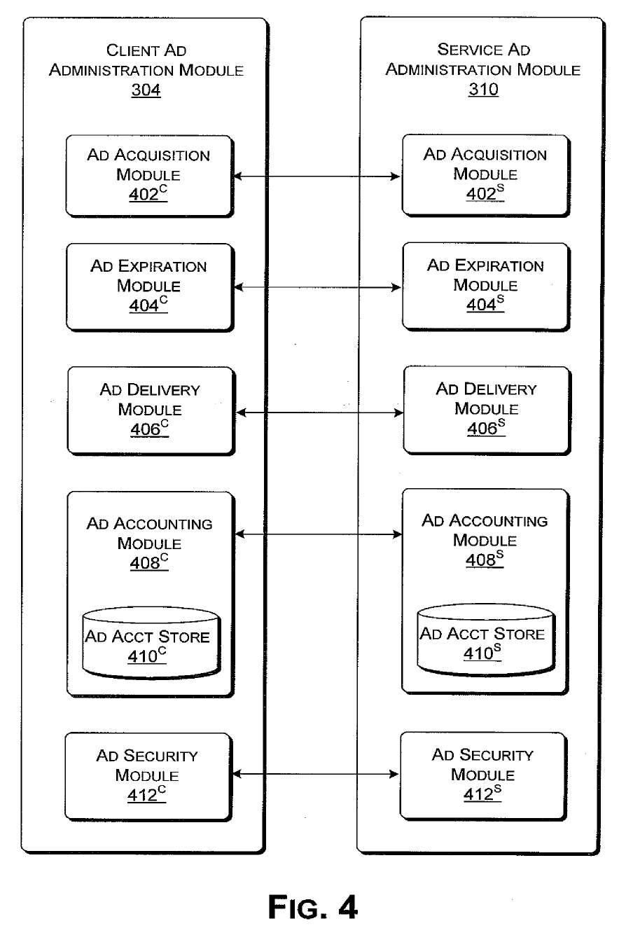

FIG. 4 shows the exemplary composition of the client ad administration module 304 and the service ad administration module 310, which were introduced in the context of FIG. 3. As described, these ad administrative modules (304, 310) perform various aspects of ad handling. The components of the client ad administration module 304 complement the components of the service ad administration module 310. For this reason, complementary pairs of components are labeled with the same reference number and are marked with the subscript “C” to denote the client-side implementation of the component and the subscript “S” to denote the service-side implementation of the component. To facilitate discussion, any mention of a component without making reference to a subscript indicates that either the client-size implementation or the service-side implementation is being referred to, or both are being referred to.

An ad acquisition module 402 serves the role of acquiring ads for storage in the client device's 102 local store 108. Namely, the service ad acquisition module 402^{S} can select ads in conjunction with the service targeting module 314, and then forward these ads to the client ad acquisition module 402^{C} in response to respective download events. The client ad acquisition module 402^{C} then coordinates the storage of these ads in the local store 108. Or the client ad acquisition module 402^{C} can take the “lead” in orchestrating the downloading of ads, e.g., based on its local analysis.

An ad expiration module 404 serves the role of expiring (e.g., deleting) ads that have been previously downloaded to the local store 108. Namely, the service ad expiration module 404^{S} can select ads to be deleted based on any number of expiration considerations, and then forward instructions to the client ad expiration module 404^{C} to expire the identified ads. These instructions define respective expiration events. The client ad expiration module 404^{C} then executes the instructions by expiring the identified ads, such as by deleting the ads from the local store 108 or by otherwise deactivating these ads. Or the client ad expiration module 404^{C} can independently make a decision to delete ads based on its own analysis.

An ad delivery module 406 serves the role of delivering previously downloaded ads to the user in response to respective delivery events. More specifically, the client ad delivery module 406^{C} can select and retrieve the ads from the local store 108 and present the ads to the user. In one implementation, the client ad delivery module 406^{C} can also determine when to initiate the delivery operation based on various criteria described above, thus potentially eliminating the need for the server ad delivery module 406^{S}. Alternatively, the server ad delivery module 406^{S} can be used to determine when to deliver the ads. Then, the server ad delivery module 406^{S} can send instructions to the client ad delivery module 406^{C} which command it to deliver the ads.

An ad accounting module 408 performs various functions associated with the reporting of revenue-accruing accounting events. As previously described, an accounting event may correspond to the mere delivery of an ad. Or an accounting event may correspond to some action that the user takes with respect to a delivered ad, such as by activating the ad (e.g., clicking on the ad), filling out a form based on the ad, making a purchase based on the ad, and so forth. In one implementation, the client ad accounting module 408^{C} can be tasked with the responsibility of detecting the accounting event, creating corresponding accounting information, and forwarding the accounting information to the server ad accounting module 408^{S} at the IDS 104. The server ad accounting module 408^{S} can then perform further processing on the accounting information, such as by extracting data from the accounting information, identifying parties involved in the delivery of the ad, sharing revenue among the parties, and so forth.

More specifically, as will be set forth more fully in subsection A.4 (below), the ad accounting module 408 collects highly granular data regarding an ad-related transaction. Part of this data pertains to what actions were performed in the delivery of the ad, including what actions a user may have taken in response to the delivery of an ad. Another part of this data identifies participants that played a role in the delivery of the ad. Possible parties involved in the delivery of an ad may include, but are not limited to: a manufacturer of a device on which the ad was presented; an application that hosted the presentation of an ad; one or more computer network operators that played a role in the delivery of the ad; one or more landline and/or wireless communication network operator that played a role in the delivery of an ad; one or more gateway interfaces through which the ad passed, and so on. (As will be appreciated by one skilled in the art, the participants that play a role can be expected to vary depending on environment-specific considerations.) An advertising service can use all of this ad-related data to determine how revenue associated with the delivery of an ad should be shared among the parties involved in the delivery of the ad.

To implement the above-described ad-related record keeping, the ad accounting module 408 can store ad-related information at various locations within the system 100. For example, the client-side ad accounting module 408^{C} can maintain ad-related information in a client-side ad accounting store 410^{C}. The service-side ad accounting module 408^{S} can maintain ad-related information in a service-side ad accounting store 410^{C}.

One exemplary (but non-limiting) method for actually collecting and propagating ad-related information is described in subsection A.4 (below).

An ad security module 412 performs various functions designed to better ensure the integrity of operations performed by the other modules, such as the accounting module 408. For instance, the ad security module 412 can ensure that the generated accounting events represent legitimate cost-accruing events, rather than an attempt by some entity to defraud the accounting process for any reason. For instance, consider the case of an application developer which stands to receive revenue each time an ad is presented during the running of its application. An unscrupulous developer might be motivated to artificially inflate the number of ads that were actually delivered to the user in the course of running the application.

The ad security module 412 can be implemented in different ways. In one implementation, the server ad accounting module 412^{S} can initially refuse to download ads to any applications and/or users unless these entities have been pre-authorized to receive ads. Alternatively, or in addition, the server ad accounting module 412^{S} can refuse to receive accounting information from applications and/or users unless these entities have been pre-authorized to provide accounting information. The server ad accounting module 412^{S} can implement this feature through a certification provision, where a trusted source can provide applications and/or users with certificates that vouch for the identity of the applications and/or users.

In another case, the server ad accounting module 412^{S} can also provide the applications and/or users within session IDs, e.g., at the time when the server ad accounting module 412^{S} downloads ads to the client devices. The client devices can return the session IDs to the IDS 104 when they report accounting information. The IDS 104 can use this ID information to validate the legitimacy of the applications and/or users. The session IDs can have expiration times, making them usable for only defined periods of time.

A.4. Accounting Functionality

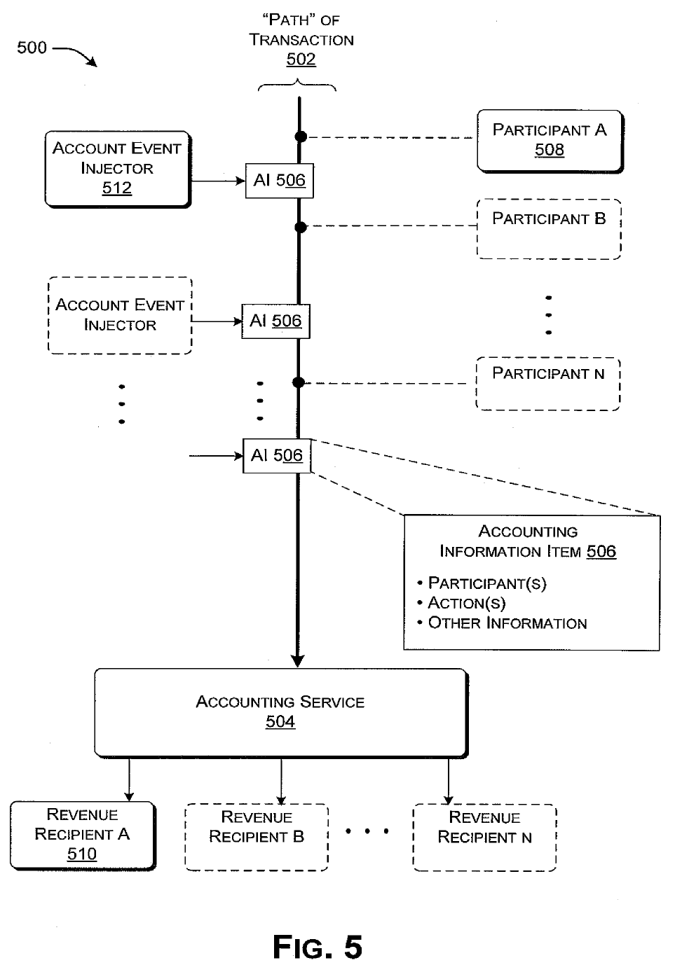

FIG. 5 shows accounting functionality 500 that sets forth a framework for generating and processing accounting information. As described above, the system 100 performs accounting operations to register the delivery of previously downloaded ads, or to record other actions that the user makes in response to the delivered ads. The system 100 uses the accounting information to allocate revenue among one or more participants involved in delivering the ads.

Accounting operations take place along a so-called transaction path 502. The transaction path 502 in FIG. 5 symbolizes a sequence of operations that are performed by the system 100 related to the delivery of an ad. The transaction 502 path may involve plural actors which perform different respective operations. In one exemplary case, the transaction path 502 can begin when the IDS 104 downloads an ad to the local store 108 of the client device 102 upon request, and can end when an accounting service 504 (or some other component) performs final revenue-related accounting in response to the delivery of the ad by the client device 102. The accounting service 504 may represent (or may include) the server ad accounting module 408^{S} described above in connection with FIG. 4.

The accounting functionality 500 manages its accounting tasks by using one or more account information items (AIIs) 506 to annotate the flow of information along the transaction path 502. (To facilitate explanation, the ensuing discussion makes reference to a single AII). An AII 506 comprises a unit of data that contains salient information regarding the transaction. For instance, an AII 506 may contain information that identifies actions that take place along the path 502. The AII 506 may also identify participants that have some type of role in the processing of information at different stages of the path 502. One such participant is exemplary participant A 508. As a transaction proceeds along the path 502, an AII can increase the amount of information it contains regarding the transaction. When the AII 506 reaches the accounting service 504, it can include a complete record of actions that have transpired during the course of the transaction, as well as the parties that had a role in performing these actions.

The accounting service 504 can extract data from the AII 506 and use it to perform various accounting-related tasks, such as allocating ad revenue to contributing parties. Because the accounting information contains a highly granular breakdown of what happened in the course of a transaction, the accounting service 504 can provide an equally detailed allocation of revenue based on the accounting information. FIG. 5 shows that the accounting service 504 allocates revenue to various revenue recipients, including representative revenue recipient A 510.

For example, consider a system that uses an IDS 104 to distribute ads to a mobile client device 102 over networks 106. Assume that the mobile client device 102 uses an application 302 that requests one or more ads in the course of its execution. Further, assume that the networks 106 employ one or more Internet links and one or more wireless communication links. In operation, the application requests an ad from the IDS 104 via the networks 106. The IDS 104 receives the ad from any appropriate advertising information source 112. The IDS 104 then forwards the ad back through the networks 106 to the client device 102. The client device 102 may eventually present the ad in response to a delivery event.

In the above scenario, the transaction path 502 includes numerous potential actors, such as a designer of the application, a manufacturer of the client device 102 itself, an Internet service provider, one or more landline telecommunication service providers, one or more wireless carriers, one or more gateway operators, an entity which administers the IDS 104, an entity associated with the advertising information source 112, and so on. (Alternatively, one or more of these entities may pertain to the same participant.)

In its journey along the transaction path 502, one or more AIIs 506 can accumulate salient information regarding the transaction. Such information may describe the nature of the transaction, such as the identity of the ad in question. Such information may also indicate whether the ad has been presented to the user, what actions the user performed in response to the ad (such as clicking on the ad to discover more about the ad), and so on. Another piece of information may describe the participants involved in the transaction, including any one or more of the parties identified above (as well as other possible parties). The accounting service 504 can perform accounting operations based on data extracted from the AII 506, such as by allocating advertising-revenue to one or more of the participants identified above.

One way of implementing the accounting functionality 500 shown in FIG. 5 is through the use of one or more account event injectors, such as representative account event injector 512. The purpose of the account event injector 512 is to discover salient information regarding a particular stage of the transaction and to inject such information into the AII 506. To function in this manner, the system 100 can strategically place different account event injectors at different locations within the system 100. For example, the client device 102 can include an account event injector which potentially supplies information that identifies the application that has invoked the downloading of an ad, the manufacturer of the client device 102, and so forth. A gateway interface 110 can include another account event injector to tag information which passes through it with data that identifies various network and/or gateway operators, and so on. The client-side accounting module 408^{C} can include an account injector to record the actions that the user takes with respect to a delivered ad, and so forth.

As one skilled in the art will appreciate, the placement of account event injectors within a system can depend on the technical characteristics of the system and other environment-specific factors. An account event injector 506 can be implemented by software, firmware, hardware, or any combination of these implementations.

In one exemplary implementation, the AII 506 can be implemented as packets of information. For example, the AII 506 can be embodied as header information within a Simple Object Access Protocol (SOAP) packet, or some other type of packet. The following co-pending and commonly assigned U.S. Application describes one exemplary format of a billing-related SOAP message that can be adapted for use in the above-described advertising context: U.S. application Ser. No. 11/118,719, entitled “Wireless Internet Services Billing,” filed on Apr. 29, 2005, naming the inventors of Quentin S. Miller and John J. Ostlund. The '719 Application is incorporated by reference herein in its entirety.

A.5. Exemplary Processing Functionality

Various aspects of the system 100 described in the preceding figures can be implemented by information processing equipment, including any combination of software, firmware, and hardware. FIG. 6 sets forth exemplary processing functionality 602 that can be used to implement any aspect of the system 100. For example, the processing functionality 602 describes one basic architecture for implementing any one or more of: the client device 102; any network equipment within the networks 106 (such as a gateway interfaces 110); the IDS 104; the information source 112, and so on.

The processing functionality 602 can include various volatile and non-volatile memory, such as RAM 604 and ROM 606, as well as one or more central processing units (CPUs) 608. The processing functionality 602 can perform various operations identified above when the CPU 608 executes instructions that are maintained by memory (604, 606). The processing functionality 602 also optionally includes various media is devices 610, such as a hard disk module, an optical disk module, and so forth.

The processing functionality 602 also includes an input/output module 612 for receiving various inputs from the user (via input devices 614), and for providing various outputs to the user (via output devices 616). The processing functionality 602 can also include one or more network interfaces 618 for exchanging data with other devices via one or more communication conduits (e.g., networks). One or more communication buses 620 communicatively couple the above-described components together.

B. Exemplary Method of Operation

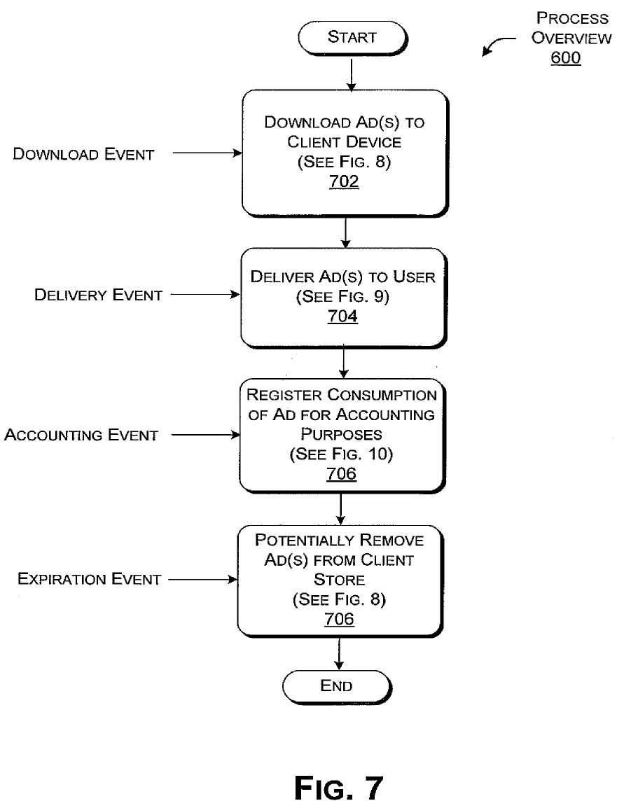

FIGS. 7-10 describe the operation of the system 100 in flowchart form. To facilitate discussion, certain operations are described as constituting distinct steps performed in a certain order. Such implementations are exemplary and non-limiting. Certain steps described in these flowcharts can be grouped together and performed in a single operation, and certain steps can be performed in an order that differs from the order shown in the flowcharts. As the functions described in these flowcharts have already been explained in prior sections, Section B will serve primarily as a review of those functions. To provide concrete but non-limiting example, Section B will explain the process flow in an advertising-related context.

B.1 Overview of Processing

FIG. 7 shows a procedure 700 which represents an overview of one manner of operation of the system 100 of FIG. 1.

In step 702, the system 100 downloads one or more ads to the client device 102 in response to one or more respective download events. For example, the user may be interacting with a client application 302. A juncture is reached in the application 302 in which the application 302 calls for the presentation of an ad. In response, the client device 102 sends a request to the IDS 104, whereupon the IDS 104 forwards an ad to the client device 102 for storage in its local store 108. Other download events may represent triggering occurrences associated with backend processing performed by the IDS 104 and/or the information source 112. Moreover, in the hybrid case described in the previous section, the downloading of ads may reflect the periodic transmission of ads, where the IDS 104 has previously selected these ads in response to various triggering events.

In step 704, the client device 102 retrieves and presents the previously downloaded ad in response to a delivery event. A delivery event can represent some action taken by the user or some backend occurrence unrelated to the user's activity. For instance, the system 100 can deduce that the user is interested in fishing based on a large number of websites or fishing-related applications that the user has accessed in the recent past. This causes a triggering event which leads to the downloading of one or more fishing-related ads to the client device 102. Then, when the user next makes a fishing-related selection, the client device 102 can retrieve and present one or more previously downloaded fishing-related ads. The user's subsequent fishing-related selection constitutes a delivery event.

In step 706, the accounting functionality 500 records accounting information associated with the consumption of the delivered ad by the user. As described above, the accounting information can collect salient information regarding the ad transaction which can later be mined to allocate revenue associated with the presentation of the ad. Step 706 occurs in response to an accounting event, which corresponds to the presentation of an ad or some other action that the user takes with respect to a presented ad.

In step 708, the system 100 potentially removes one or more previously downloaded ads in response to one or more respective expiration events. As described above, the expiration events may represent different occurrences within the system 100, such as the expiration of a predetermined time interval, a change in advertising context, and so forth. While the delivery and accounting steps (706, 708) precede the expiration step 708, it should be noted that it is possible that a downloaded ad may never receive an opportunity to be presented before it is deleted.

B.2. Ad Delivery and Expiration Processing

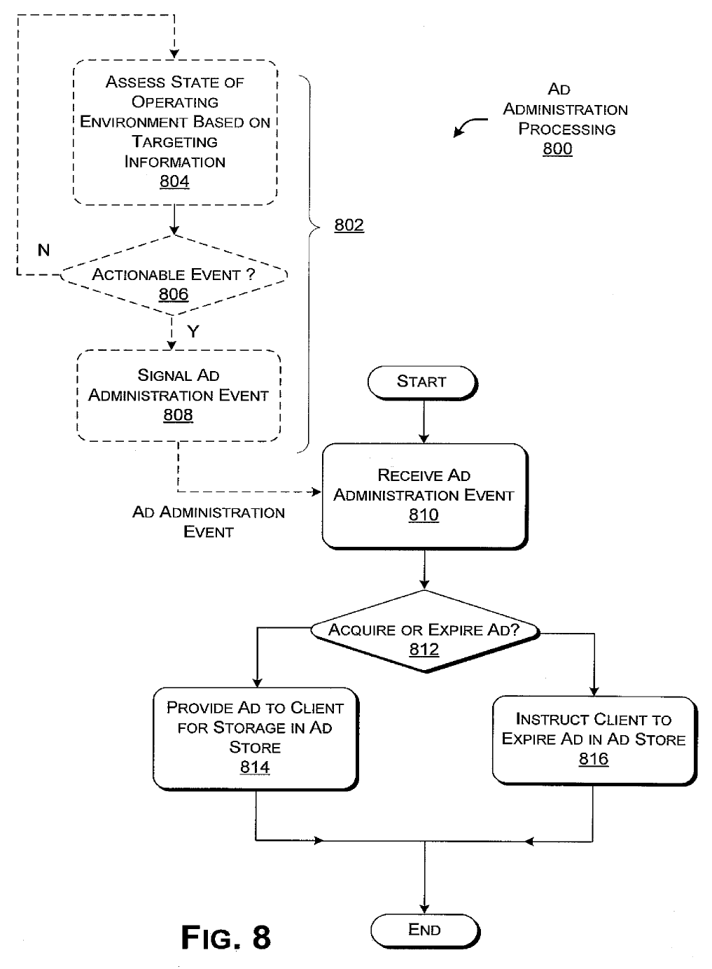

FIG. 8 shows a procedure 800 for adding new downloaded ads to the local store 108 and for deleting previously downloaded ads from the local store 800. The steps shown in FIG. 8 can be performed at the local client level, the service (IDS) level, by a combination of local and service levels, or by some other implementation. Accordingly, the specific explanation of procedure 800 corresponds to only one exemplary implementation of the procedure 800.

To begin with, sub-procedure 802 corresponds to a technique for monitoring the system 100 to determine whether an ad-related administrative event has occurred. An ad-related administrative event corresponds to a triggering circumstance which causes the addition of an ad to the local store 108 or the removal of an ad from the local store 108.

In step 804, the system assesses the current state of the operating environment to determine whether an administrative event has occurred. This operation has broad connotation. It can involve determining whether the user has opened an application, closed an application, performed some function within an application, sent an Email message or other kind of message, received an Email message or other kind of message, entered a search term into a search engine, and so forth. Step 804 can alternatively (or additionally) correspond to the detection of a backend event that occurs at the IDS 104 or other remote component of the system 100 that does not depend on user input. Further, as explained, the event in question may correspond to a periodic occurrence. Any of these types of events can constitute a triggering event (an administrative event) which prompts the downloading of an ad or the removal of an ad.

In step 806, the system 100 examines a detected change of system state to determine whether it constitutes an actionable administrative event. Generally, the system 100 can perform the operations of steps 804 and 806 as an ongoing monitoring process, in parallel with other operations performed by the system 100. In step 808, the system signals an administrative event if step 806 is answered in the affirmative.

Upon determination that an actionable administrative event has occurred, the system 100 takes action based on this event. Namely, in step 810, the system 100 receives the administrative event. For example, in one non-limiting implementation, the client device 102 can detect the event and send it to the IDS 104 for processing.

In step 812, the system 100 determines whether the administrative event warrants the downloading of an ad to the local store 108, or the deletion of a previously downloaded ad from the local store 108. In the first scenario, the administrative event constitutes a download event. In the second scenario, the administrative event constitutes an expiration event.

In step 814, if a download event has been generated, the system 100 downloads at least one ad to the local store 108 of the client device 102.

In step 816, if an expiration event has been generated, the system 100 can send an instruction to the client device 102, which instructs the client device 102 to delete (or other deactivate) a previously downloaded ad.

B.3. Procedure for Delivering an Ad

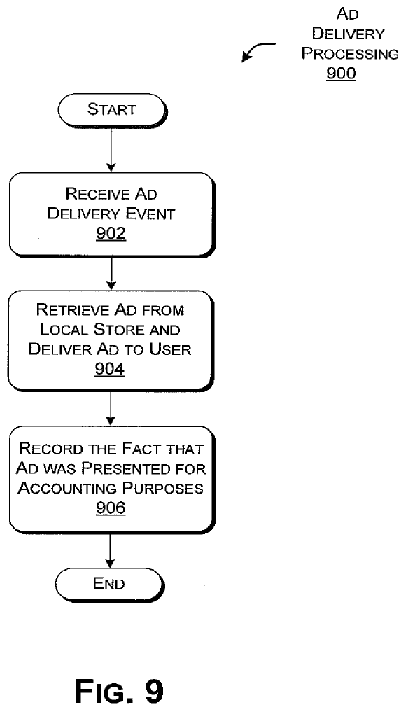

FIG. 9 shows a procedure 900 for delivering previously downloaded ads to the user in response to delivery events. The steps shown in FIG. 9 can be performed at the local client level, the service IDS level, by a combination of local and service levels, or by some other implementation. Accordingly, the specific explanation of procedure 900 corresponds to only one exemplary implementation of the procedure 900.

In step 902, the system 100 receives a delivery event. The delivery event instructs the client device to retrieve a previously downloaded ad from the local store 108 and present it to the user for consumption. The delivery event can correspond to various triggering circumstances discussed above, such as actions made by the user, backend events, and so forth. The instruction to deliver an ad can originate from the client device, the IDS 104, some other component, or by any combination of processing performed at different levels.

In step 904, the system 100 retrieves the ad from the local store 108 and presents it to the user. The presentation can involve a visual presentation, audio presentation, etc., or any combination thereof.

In step 906, the system 100 records the fact that the ad has been presented. Additionally, step 906 can involve recording any action that the user may perform in response to the ad, such as clicking on the ad, filling out a form, contacting a personal representative, making a purchase, and so forth. This information allows the accounting functionality 500 to perform its role, as will be described next.

B.4. Procedure for Accounting for Ad Consumption

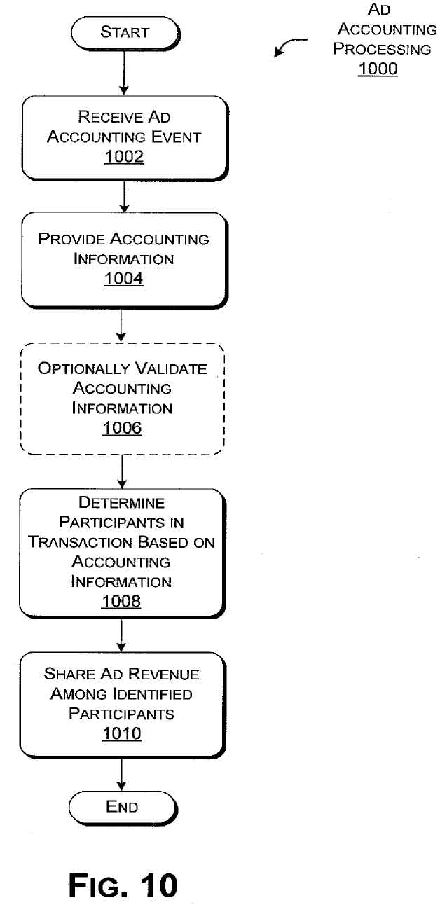

FIG. 10 shows a procedure 1000 for processing accounting information associated with the user's consumption of an ad. The steps shown in FIG. 10 can be performed at the local client level, the service IDS level, by a combination of local and service levels, or by some other implementation. Accordingly, the specific explanation of procedure 1000 corresponds to only one exemplary implementation of the procedure 1000.

In step 1002, the system 100 receives an accounting event. As described above, an accounting event may reflect that an ad has been displayed and/or that the user has taken some action with respect to a presented ad.

In step 1004, the system 100 generates and forwards accounting information items (AIIs) that describe the accounting event. As set forth in the context of FIG. 8, an AII can describe the nature of the transaction, such as by identifying what ad has been presented and how the user has responded to the ad. The AII can also describe the participants of the system 100 that had a role in the delivery of the ad.

In step 1006, the system 100 optionally validates the accounting information to determine whether it represents a legitimate delivery of an ad to a user (as opposed to an artificial event produced to defraud the system 100 for some reason). This can be performed by ensuring that the account information originates from a known application or client device, and/or ensuring that the accounting information is associated with a valid session ID, and so forth.

In step 1008, the system 100 can extract data from the account information and, based thereon, determine the system actors involved in the delivery of the ad.

In step 1010, the system 100 can allocate ad revenue to one or more parties based on the analysis of step 1008. Revenue sharing is just one accounting-related operation. Step 1010 can involve performing other accounting-related operations based on the accounting information.

In closing, a number of features were described herein by first identifying exemplary problems that these features can address. This manner of explication does not constitute an admission that others have appreciated and/or articulated the problems in the manner specified herein. Appreciation and articulation of the problems present in the relevant art(s) is to be understood as part of the present invention. Further, identification of one or more needs in the relevant art(s) does not suggest that the subject matter described herein is limited to solving these needs; the subject matter may address additional needs.

Further, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is,

1. A method for delivering an information item to a client device over a communication coupling characterized by at least episodes of non-real-time response performance, comprising:
selecting at least one information item in response to an item download event; and
forwarding said at least one information item to the client device for storage,
wherein the client device delivers said at least one information item upon the occurrence of at least one delivery event.

2. The method of claim 1, wherein the information item comprises an advertisement.

3. The method of claim 1, wherein the communication coupling comprises a wireless communication coupling, and the client device comprises a mobile client device.

4. The method of claim 1, wherein the communication coupling comprises a low-speed wired communication coupling.

5. The method of claim 1, her comprising receiving targeting information that reflects a state of an operating environment, wherein the selecting is based on the targeting information.

6. The method of claim 1, wherein the item download event reflects a recent occurrence, and wherein said selected at least one information item is associated with the recent occurrence.

7. The method of claim 1, wherein the item download event reflects a long-term pattern, and wherein said selected at least one information item is associated with the long-term pattern.

8. The method of claim 1, wherein the item download event is prompted by activity that occurs at the client device.

9. The method of claim 1, wherein the item download event is prompted by activity that occurs at a network-accessible information downloading service that is remote from the client device.

10. The method of claim 1, further comprising retiring a previously forwarded information item based on an item expiration event.

11. The method of claim 1, further comprising generating accounting information in response to the delivery of said at least one information item.

12. The method of claim 11, further comprising:
identifying, based on the accounting information, two or more one participants associated with the delivery of the information item; and
allocating revenue associated with the delivery of the information item among said two or more participants.

13. The method of claim 11, further comprising performing an operation to better ensure that the accounting information reflects a valid delivery event.

14. One or more machine-readable media containing machine-executable instructions for implementing the selecting and forwarding of claim 1.

15. An apparatus including logic configured to implement the selecting and forwarding of claim 1.

16. A method for delivering an information item to a client device over a communication coupling characterized by at least episodes of non-real-time response performance, comprising:
receiving at least one information item from a network-accessible information downloading service in response to an item download event;
storing said at least one information item in a client-side information item store;
identifying an item delivery event, subsequent to the item download event;
retrieving said at least one information item from the client-side information item store in response to the item delivery event; and
presenting said at least one information item to a user for the user's consumption.

17. The method of claim 16, wherein the information item comprises an advertisement.

18. One or more machine-readable media containing machine-executable instructions for implementing the receiving, storing, identifying, retrieving, and presenting of claim 16

19. An apparatus including logic configured to implement the receiving, storing, identifying, retrieving, and presenting of claim 16.

20. A system for delivering information items, comprising:
at least one client device configured to present at least one information item, wherein said at least one client device includes an information item store for retaining said at least one information item in advance of its presentation;
an information downloading service for forwarding said at least one information item to the information item store in response to a download event;
an information item source for providing said at least one information item to the information downloading service; and
a communication coupling, connecting said at least one client device with the information downloading service, characterized by at least episodes of non-real-time response performance.
